(19) United States
(12) Patent Application Publication
(10) Pub. No.: US 2009/0094164 A1
(43) Pub. Date: Apr. 9, 2009

(54) REMOTE ACCESS VERIFICATION ENVIRONMENT SYSTEM AND METHOD

(75) Inventors: Anthony L. Fontaine, Henderson, NV (US); Hyon John Im, Addison, IL (US); Wesley Park, Aurora, IL (US)

Correspondence Address: BALLY GAMING INC., 6601 S. BERMUDA ROAD, LAS VEGAS, NV, 89119, US

(73) Assignee: Bally Gaming, Inc., Las Vegas, NV (US)

(21) Appl. No.: 12/235,559

(22) Filed: Sep. 22, 2008

Related U.S. Application Data
(62) Division of application No. 10/033,716, filed on Dec. 27, 2001.
Application No. 10/033,716 is a continuation of application No. 09/854,438, filed on May 11, 2001, now abandoned.
Application No. 09/854,438 is a continuation of application No. 09/612,476, filed on Jul. 7, 2000, now abandoned.
(60) Provisional application No. 60/145,068, filed on Jul. 9, 1999.

(51) Int. Cl. H04L 9/00

(52) U.S. Cl. 705/67

(57) ABSTRACT

A system and method for authentication of the location of a user requesting remote access to an application server for processing a transaction requiring user location authentication. The system includes a client for enabling the user to request remote access to the application server, an access server for receiving and processing the request for access, an authenticating server for authenticating the user location responsive to receipt of the processed request from the access server, and a network for interconnecting the client, the access server, the authenticating server, and the application server. The client includes an identifier associated with the user's location, and the authenticating server is adapted to authenticate the client location identifier. The client may include a dialer, including a number associated therewith, and the authenticating server may be adapted to identify the number associated with the dialer to authenticate the user's location, and may further be adapted to identify the first number dialed to further authenticate the user location. The authenticating server may issue a security challenge to the client, and the client may interrogate the security challenge, generate a response, and transmit the response to the authenticating server.

### RELATED APPLICATIONS

This application is a divisional application of, and claims priority from, co-pending U.S. patent application Ser. No. 10/033,716 filed on Dec. 27, 2001, which is a continuation of U.S. patent application Ser. No. 09/854,438 filed on May 11, 2001, which is a continuation of U.S. patent application Ser. No. 09/612,476 filed on Jul. 7, 2000 which claims the benefit of U.S. provisional patent application 60/145,068 filed on Jul. 9, 1999.

All of the above referenced applications are hereby incorporated by reference in their entireties for all purposes.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

This invention relates generally to improvements in remote access verification systems and, more particularly, to a remote access verification environment system and method for enabling remote access to an application server, wherein a user's location and/or jurisdiction needs to be verified for enabling processing of a transaction requiring such user location verification.

2. Description of the Related Art

The present invention is directed to verification of geographic location for enabling remote access to an application server, and is particularly applicable to transactions requiring user location verification, such as gambling transactions, wherein processing gambling information for the purposes of wagering is restricted to venues where it is allowable by law.

Gambling transactions, in some form, are currently legal in 48 states in the United States and in many foreign countries. In order to insure consumer protection, gambling is highly regulated by the jurisdiction in which the activity occurs. Each jurisdiction sets its own standards for regulation including, for example, what games may be played, what the payouts must be, and consumers' recourse for the redress of grievances. Typically, gambling regulations will differ from jurisdiction to jurisdiction depending upon the social perspective on gambling in that jurisdiction. In the past, the enforcement of these regulations has been facilitated due to the nature of the activity, in that physical presence at the activity confirmed that the activity was performed within the authorized jurisdictional boundaries.

The concept of telephone wagering, e.g., consisting of betting from remote locations removed the requirement of physical presence at the gambling location and, thus, enabled a wagerer to place a bet from a remote location through a telephone without actually being physically present in the jurisdiction. In this regard, the Federal legislation known as the Wire Act has now made it illegal to use a wire for the interstate transmission of wagering information.

However, with the advent of the Internet as a medium for the placing of bets or wagers, the applicability of the Wire Act to the Internet has been at issue. Proponents of the Internet gaming argued that the Internet was not a wire medium and therefore the law was not applicable to their activity. Furthermore, since most of the Internet gambling sites are currently located offshore and not within United States jurisdiction, proponents have argued that if the activity is legal in their jurisdiction, they are not in violation of United States laws.

Legislation has been introduced to specifically cover use of the Internet for wagering purposes, including the Internet Gambling Prohibition Act. Although this act is described as a prohibition against the use of the internet for gambling purposes, there are specific exemptions for industries using specific technology. Under this act, industries such as horse racing and state lotteries may employ a technology defined as Closed-Loop Subscriber-Based Service for the purpose of wagering, provided that the service can verify that the person is physically located in a state where the activity is legal.

Therefore, those concerned with the development and use of improved remote access verification systems, methods, and the like have long recognized the need for improved systems and methods for determining and verifying a user's geographic location for enabling access to the processing of transactions requiring such user location verification.

### SUMMARY OF THE INVENTION

Briefly, and in general terms, the present invention provides a new and improved system and method for authenticating the geographic location of a user, identifying the user, and permitting the user to access an application server for transaction processing in an efficient, effective, and secure manner.

By way of example, and not by way of limitation, the present invention provides a remote access verification environment system and method for enabling and verification of remote access to an application server upon authentication of a location from which a user has sought access. The system is adapted to authenticate the user location to determine whether the user's location is an authorized location for enabling access to the application server.

More particularly, the present invention may include a client for enabling the user to request remote access to the application server, an access server for receiving and processing a request for access to the application server from the client, adapted to be located remote from the user's location, an authenticating server for authenticating the location of the user responsive to receipt of the processed request from the access server, adapted to be connected to the access server, and a network for interconnecting the client, the access server, the authenticating server, and the application server. The client may include an identifier associated with the user's location, such as a cookie, or a dynamic cookie, and the authenticating server may be adapted to authenticate the client location identifier. The client may further include a dialer located at the user's location, with a number associated with the dialer, and the authenticating server may comprise a Remote Access Dial-In User Service (RADIUS) server. The RADIUS server can include a system for authenticating the dialer number, which may be accomplished via Automatic Number Identification (ANI) system, and a system for identifying the first number from which the user has dialed, which may be accomplished via a Dialed Number Identification Services (DNIS) system. The authenticating server may also include a database of authorized locations, for enabling verification of the location of the user as an authorized user location. The network may comprise an intranet, it may include a local area network, or alternatively, it may comprise the Internet.

The system, in accordance with the present invention, may also include a system for determining the identity of the user, which may comprise a challenge and response system, wherein the authenticating server may issue a security challenge to the client, and the client may interrogate the security challenge, generate a response, and send the response to the authenticating server. The present invention may further include a system for insuring the user's presence at the location from which the request has been sent, which may consist of a card, e.g., a Smart Card, for identifying the user, and a reader for reading the card and forwarding the information to the authenticating server. The user may access the client at a location remote from the application server, for example from the user's home, office, or kiosk. The client may further include a communications port, a facility for the loading of software such as a disk drive, compact disk drive, or a communications port, a storage area for a geographic identifier, software that controls the communications port, a processing unit to interpret the communications, and output device such as a video display or television for communications output, and an input device such as a keyboard, mouse, touch screen, or voice recognition for communications input.

In accordance with the present invention, the user may establish contact with the application server directly through a proprietary or private network, or indirectly through the Internet or a virtual private network, through enabled proxy and Web servers. Once a link between the user's client and an authenticating server has been effected, the server may query the client processing unit for information regarding the controller for the communications port. The processing unit may relay the geographic identification information contained in the communications controller to the authenticating server. During this process, the user may receive messages from the authenticating server that will be displayed on the output device. The user may be prompted to supply additional user information that may be entered through the input device. The user's geographic location identifier, as well as other pertinent information may be stored in a user account database. Successful logon to the authenticating server may activate the user's account, and may become available for tracking by the authentication-enabled application. Upon disconnection of the user, the account may be deactivated, whereupon all session specific information may be removed from the user's record. In addition, unsuccessful logon attempts may be reported, logged, and the user disconnected, thereby refusing access to the application server.

Therefore, an advantage of the present invention is that it includes a system for securely and effectively verifying the location of a user requesting access to an application server, for enabling the secure and effective processing of a transaction requiring user location verification.

A further advantage is that the present invention provides efficient and effective systems for insuring the user's presence at the location from which access is requested, to enable effective and efficient authentication.

These and other objects and advantages of the invention will become apparent from the following more detailed description, when taken in conjunction with the accompanying drawings of illustrative embodiments.

### BRIEF DESCRIPTION OF THE DRAWINGS

FIG. 1 is a schematic diagram of a remote access verification system in accordance with the present invention.

FIG. 2 is a block diagram illustrating a client system for communicating with an application server, in accordance with the invention.

FIG. 3 is a block diagram of a system for communicating between a client and a remote Web server, in the practice of the present invention.

FIG. 4 is a block diagram showing a security system for an Internet Service Provider Web server, in the practice of the invention.

FIG. 5 is a block diagram of a system for enabling a client to access a remote Web server, in accordance with the present invention.

FIG. 6 is a block diagram of a client security authenticating system, in the practice of the invention.

FIG. 7 is a block diagram of a client geographic verification system in accordance with the invention.

### DETAILED DESCRIPTION OF THE INVENTION

The present invention is directed to a remote access verification environment system and method, for enabling remote access to an application server, upon authentication as an authorized remote location from which a user has sought such access to the application server and for enabling access authentication. The improved system and method of the present invention to the application server for the processing of a transaction requiring such user location provides efficient, effective, and secure verification of the location of the remote access request for enabling access to the application server. The preferred embodiments of the improved system and method are illustrated and described herein by way of example only and not by way of limitation.

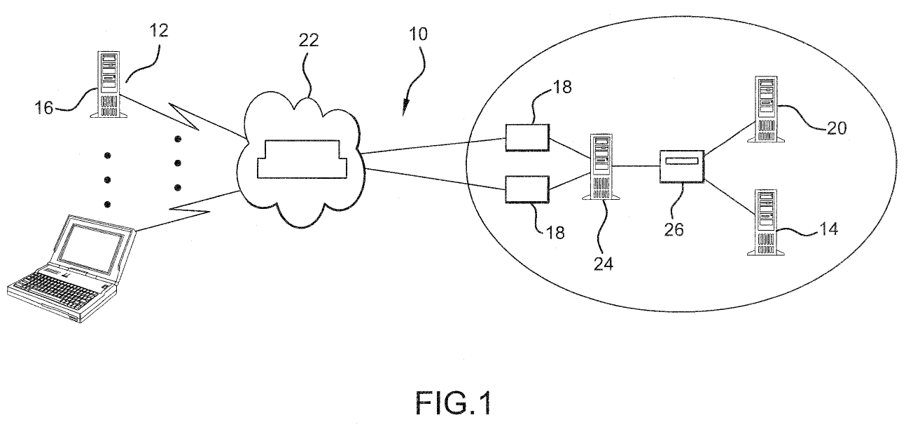

Referring now to the drawings, wherein like reference numerals denote like or corresponding parts throughout the drawing figures, and particularly to FIGS. 1-7, and more particularly to FIG. 1, a system 10 is utilized for enabling verification of a location 12 from which a user may be requesting remote access to an application server 14. The system 10 includes at least one user request enabling device 16 for enabling a user to request remote access to the application server 14, which user request enabling device 16 is adapted to be located at the user's location 12. The system 10 also includes at least one access server 18, for receiving and processing a request for access to the application server 14 from the user request enabling device 16, which access server 18 is adapted to be located remote from the user's location 12. It further includes an authenticating server 20 for authenticating the location 12 of the user in response to receipt of the processed request from the access server 18, adapted to be connected to the authentication server. It also includes a network 22, for interconnecting the user request enabling device 16, the access server 18, and the authenticating server 20.

The user request enabling device 16 may comprise, for example, an interface station or a client, such as, for example, a personal computer based system capable of running a browser and connecting to a remote computer, a hand held device, (such as a personal digital assistant and the like) a set top box connected to a television, or application specific devices incorporating a communication medium to a remote server, a display, and an input device. It may also include an identifier associated with the user's location 12, such as, for example, a cookie, and may include a dialer, such as for example a telephone dialer, located at the user's location 12. The dialer may include a number associated therewith, such as, for example, a telephone number. Where the user request enabling device 16 comprises a client 16, for example, it may include a dialer which may be used in conjunction with a dialing system which includes a plurality of numbers, each number associated with one of a plurality of dialers adapted to enable dialing therefrom, and each associated with a different user location. The dialing system may comprise, for example, a telephone system, which may include assigned telephone numbers. In such a system, the authenticating server 20 may comprise, by way of example, a Remote Access Dial-In User Service (RADIUS) server, or another server which includes dial up user validation software adapted to validate a user by comparing logon name, password, and the like, with jurisdictional values in a database or table.

In such a dialing system, the authenticating server 20 may include a system for identifying the number associated with the dialer located at the user's location 12, which system may comprise, for example, Automatic Number Identification (ANI) service, a Calling Party Number (CNID) service provided by a local central office that identifies the originating telephone number of the user, or an Internet protocol address associated with a service provider for cable, digital subscriber line, satellite networks, and the like. Further, in such a dialing system, the authenticating server 20 may include a system for identifying the first number from which the user has dialed, to prevent a user from attempting to circumvent the system 10, e.g., by activating the dialer at the user location 12 from a location other than the user location 12, Such a first number identifying system may comprise, by way of example only, Dialed Number Identification Services (DNIS).

The authenticating server 20 in the system 10 may further include a database of authorized locations, for enabling verification of the location of the user as an authorized location. It may further include a system for determining the identity of the user, which may comprise a challenge and response system, such as, for example, software providing challenge/response authentication, or software supporting a public key infrastructure. In the challenge and response system, the authenticating server 20 may issue a security challenge to the user request enabling device 16 to verify the identity of the user. The security challenge may be issued by the authenticating server 20 in the form of a token. The client 16 may then interrogate the security challenge, generate a response, and transmit the response to the authenticating server 20. In such a system, the authenticating server 20 may include a database for enabling verification of the response of the client 16 to the security challenge, and for enabling authorization of access to the application server 14.

In accordance with the present invention, the network 22 may comprise, for example, an intranet which may include at least one local area network, adapted to interconnect at least one of the clients 16 and an access server 18, or a private network which may employ a public communications infrastructure, a cable network, a satellite network, or the like. The network 22 may alternatively comprise, for example, the Internet, for interconnecting the client and the servers in the system 10.

The system 10, in accordance with the present invention, may further include a system for insuring the user's presence at the user location 12, which may comprise a card for identifying the user, and a reader for reading the user identifying card, adapted to be connected to the client 16 at the user location 12. The card for example may comprise a magnetic stripe card, or a hand held hardware based token, used to verify both the user and the user's actual physical presence, which may employ an encrypted value in a processor that relates the card to a user, or a mechanism for recording the user's identity by storing the user's finger-print on the card itself. The card may alternatively comprise a soft token constituting software that provides attributes of a hard token without the physical device, which may be activated through a keyboard or by voice or mouse input. The reader, for example, may be a device connected directly to a computer by a serial, parallel or infrared connection, or incorporated into a client without requiring external wiring or communications, or software for use with a soft token. Furthermore, a time out feature may be employed, in accordance with the presort invention, to insure that the user is actually physically present at the user location 12. In other words, the user can be prompted to insert his card at a particular time. Failure to do so will terminate the session as the system 10 will interpret such failure to insert/respond as the user not being physically present at the user location 12.

The system 10 may also include a firewall 24 for security verification and authentication of all data seeking to pass therethrough, and a switch 26 for switching between the access servers 18, and the authenticating server 20 and application server 14. The firewall 24 may comprise, for example, a software based firewall employing packet filtering technologies, or a hardware based hardened firewall, or the like.

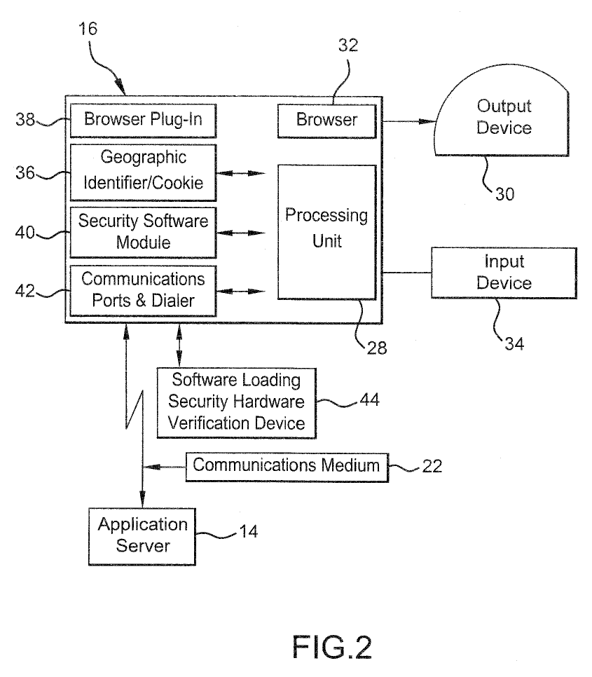

An exemplary client 16, in accordance with the present invention, is shown in FIG. 2 for communicating with an application server 14 which may be Web based. The client 16 may include, for example, a microprocessor 28 for controlling input/output, communications, and software operations, a video display 30 for viewing output communications sent from the application server 14, and a Web browser 32 or other suitable software for providing page layout display functions for the display 30. The client 16 may further include a keyboard 34 or other device for sending input communications to the application server 14, a geographic identifier 36, comprising a software program containing information regarding the geographic location and session identifier of the user, residing in storage, which may be in the form of a cookie dynamically created for each session, and a browser plug-in 38 comprising a software program for enabling the browser 32 to query the geographic identifier 36 residing in storage. The client 16 may also include a security software module 40 comprising a software program for user authentication based on hardware or software tokens residing in storage, and communications ports 42, for communicating with the remote application server 14, or for communicating with local hardware devices for software loading and security token communications with the security software module 40, which for dial-up communications includes a dialer for controlling the communications ports. The client 16 may still further include a device 44 for loading software or performing hardware scanning of authorization tokens, and the network 22 comprises the physical or virtual communications link to the remote application server 14.

In the present invention, the client 16 may comprise a personal computer, which may include the microprocessor 28, the video display 30, the Web browser 32, the keyboard 34, and the communications ports 42. The software, comprising the geographic identifier 36, the browser plug-in 38, and the security software module 40, may be obtained by the user on media loaded directly from the loading device 44, or through software downloaded from a remote server, accessed through the network 22 through the communications port 42 and installed to program in memory.

For dial-up communications, in accordance with the present invention, the geographic identifier 36 may include the dial-up phone number of an Internet Service Provider (ISP), which may include country code, area code, prefix, and number, as is appropriate by each country. The geographic identifier 36 may be in the form of a cookie, resident in memory, and established upon dial-up. The cookie may also contain session identification for the connection to a Web server. The value of the geographic identifier 36 in the cookie may be determined by the value used in the dialer. While the typically may only is capable of utilizing the local portion dial-up value to establish communications. As such, this requires that the user be within the local calling area of the ISP, thereby determining the geographic location of the client 16 to be within a certain local calling area. For cable and other communication techniques, the value in the geographic identifier 36 is input prior to the software download, which value may include the Internet Protocol (IP) address of the ISP as well as the local support number of the ISP. The geographic identifier 36 may alternatively utilize a Geographic Positioning System (GPS) for removing reliance on user input and for removing any ambiguity regarding the exact location of the client 16.

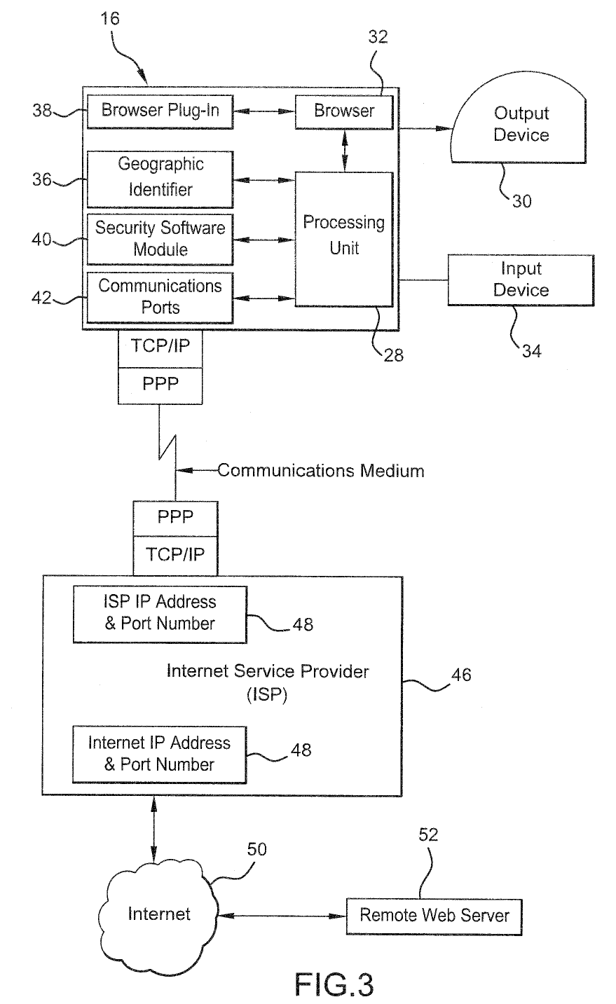

An example of a communications system, in accordance with the present invention, for communications between the client 16 and a remote Web server through an ISP 46, is illustrated in FIG. 3. The network 22 which comprises a communications medium may, for example, be a direct dial-up connection through telephone technologies, a cable connection, a satellite connection, or the like. Once the physical connection has been established, the ISP will open a Point-to-Point Protocol (PPP) connection to enable communications with the client 16 through Transmission Control Protocol/IP (TCP/IP). The ISP 46 may then assign a virtual port number and IP address 48 to the client 16. These numbers are then used to route information from the Internet 50 to the client 16. When the client 16 requests communication with a Web server 52 on the Internet 50, the ISP assigns an actual IP address and port number 48 for that particular communication with the Web server 52. Once assigned, the ISP 46 routes the communication to the appropriate IP address of the Web server 52. The ISP 46 tracks the relationship of the virtual address to the actual IP address and port number 48 used to communicate with the Web server 52. The ISP 46 dynamically assigns a different actual IP address and port number 48 for each communication with the Web server 52. Each session between the client 16 and the Web server 52 consists of may communications. The ISP 46 dynamically resolves all virtual and actual IP addresses and port numbers 48 to insure communications between the client 16 and the Web server 52. Once the communications have been established between the ISP 46 and the client 16, a graphical user interface application or browser 32 is launched. The browser 32 may be proprietary to the ISP 46, or may be commercially available, for example Netscape Navigator, Netscape Communication, Microsoft Explorer, or the like.

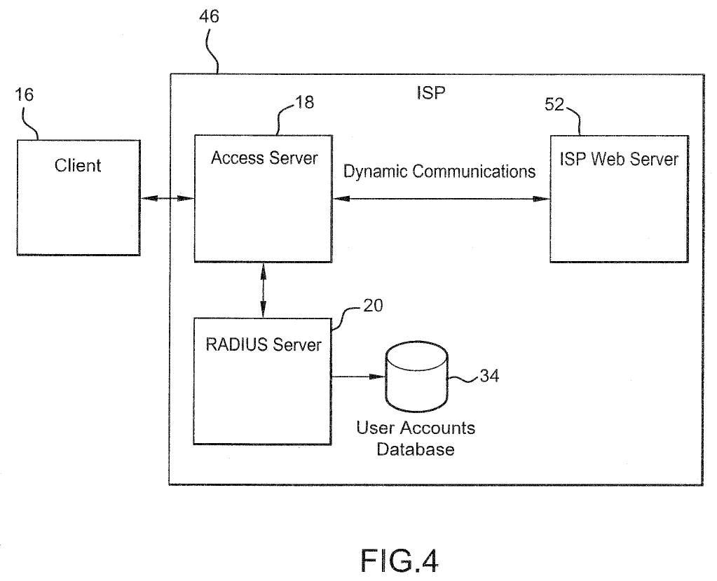

An exemplary of a security system, in accordance with the present invention, for providing a security function of verifying geographic identity upon access to the ISP 46, is shown in FIG. 4. The ISP 46 may reside on a private network and can communicate directly with the remote Web server 52. The client 16 connects to the ISP 46 through the Web server 52. The access server 18 captures relevant information regarding the geographic location of the client 16, which information may comprise ANI and DNIS. These values are interpreted by the RADIUS server 20. The RADIUS server 20 validates the user, and issues a challenge including a security token to the client 16. The client 16 interrogates the security token and receives a response which is then transmitted to the ISP 46. The RADIUS server 20 verifies the response based on values in a user accounts database 54. Upon successful verification, the RADIUS server 20 authorizes access to the ISP Web server 52 from the access server 18.

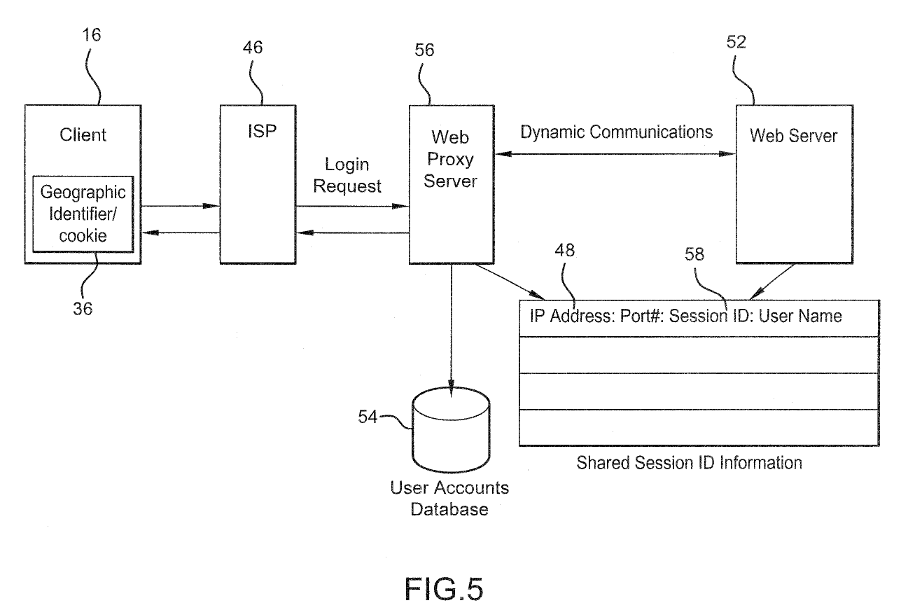

Another example, in accordance with the present invention, of a process by which the client 16 may access the remote Web server 52, by establishing communications between the client 16 and the Web server 52 through the ISP 46, is seen in FIG. 5. A proxy Web server 56 tracks communications between the client 16, the ISP 46, and the Web server 52. The client 16 accesses the ISP 46, and the ISP 46 assigns the IP address and port number 48. The geographic identifier 36 may be dynamically established in the form of a dynamic cookie. The proxy Web server 56 accesses the user accounts database 54 and assigns the user name and a session identifier 58, which will be consistent throughout the user's session with the remote Web server 52, since the actual IP address and port number 48 may change with each messaging exchange. By attributing the user name and session identifier 58 to the entire session, only the first contact requires verification, rather than requiring verification with each connection as may be required without the Web proxy server 56. Once the remote Web server 52 has received this information, it activates the security software that will begin the security authentication of the client 16.

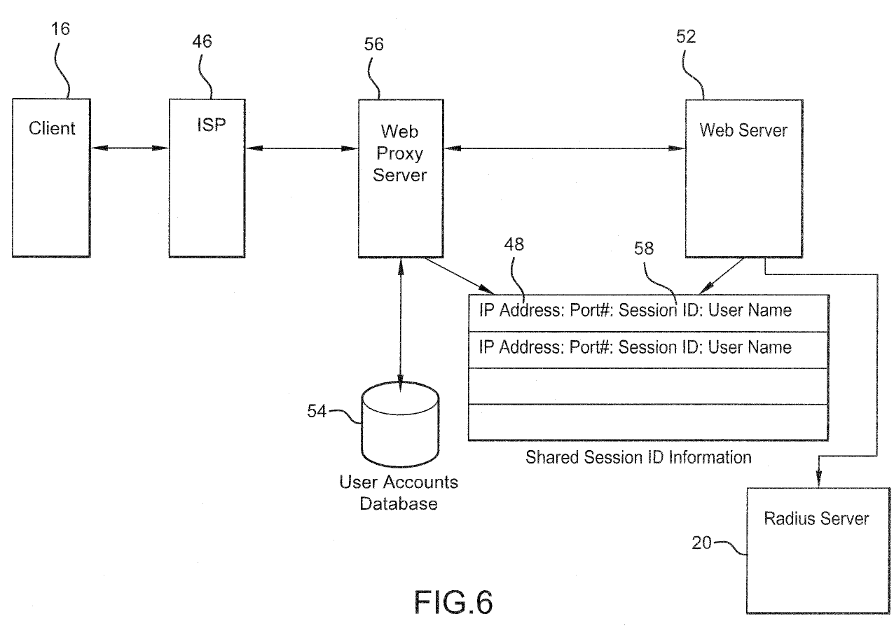

A system for security authentication of the client 16 through the remote Web server 52 is illustrated for example in FIG. 6. Once the Web server 52 has established the identity of the client 16 by the user name and session identifier 58, it prompts the RADIUS server 20 for authentication parameters. The RADIUS server 20 generates a challenge including a security token to the client 16, which is transmitted by the Web server 52 through the Web proxy server 56 and the ISP 46. The client 16 receives the challenge and queries the security token for a response. The client 16 then transmits the response to the ISP 46. The ISP 46 then transmits the response to the Web proxy server 56, which may again resolve any mapping changes of the IP address and port number 48 to the original session identification of the user name and session identifier 58. The response message is then transmitted to the Web sever 52. The Web server 52 sends the response to the RADIUS server 20 for verification of authenticity. If authentic, the RADIUS server 20 informs the Web server 52 to allow the client 16 access to the Web server 52. If authentication is rejected, the RADIUS server informs the Web server 52 to log the unsuccessful login attempt, to issue an error message to the client 16, and to disconnect the user.

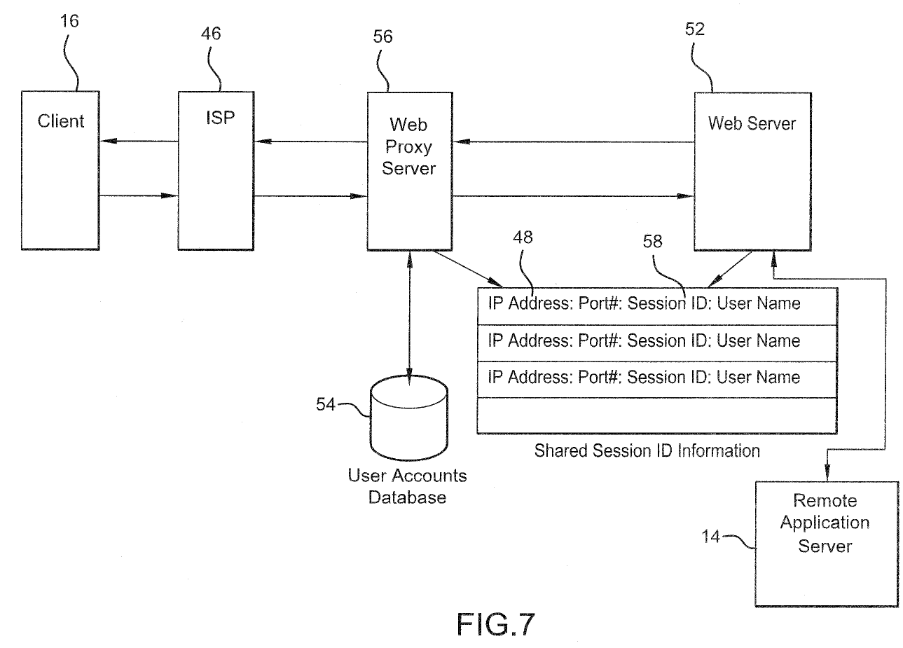

A system for geographic verification of the client 16 subsequent to the successful login to the Web server 52 is shown, for example, in FIGS. 2 and 7. Once the client 16 has completed a successful login to the Web server 52, a server application is activated to query the client for its geographic location. Communications between the Web server 52 and the client 16 are conducted through the proxy server 56 and the ISP 46. The client 16 receives the request through its browser 32 and activates its browser plug-in 38. The browser plug-in 38 queries the geographic identifier 36 of the client 16, and returns this value to the proxy server 56. The proxy server 56 compares this value against known valid values in the user accounts database 54. If acceptable, the information is logged and the client 16 is passed to the application server 14. If unacceptable, the event is logged, an error message is issued to the client 16, and the connection is disconnected.

Although one of ordinary skill in the art will appreciate that the present invention has been described above for use in all areas of communication, wherein the geographic or jurisdictional location of a user needs to be verified, in one preferred embodiment, the present invention is used in a gaming environment to allow a user to place wagers from jurisdictions in which gambling is legal. In such an embodiment, the present invention is comprised of the following components providing a secure network environment for the Internet-based delivery of gaming contact for wagering. In accordance with the present invention, the system will comprise a gaming card, e.g., a Smart Card as manufactured by Schulumberger, Inc. The gaming card will contain both security data for identifying the user and a monetary value for placing wagers. The Smart Card will be read by a Smart Card reader, for example, such as those manufactured by Fischer, Inc. One feature of the Smart Card reader, in accordance with the present invention, is the timeout feature which will require the user to be physically present at the card reader in order to insert the Smart Card therein at the appropriate time. In this way, the user cannot circumvent the system by placing the Smart Card in the reader in advance, and then dialing his computer from another remote location in order to seize control of the system and to gain access to the gaming service.

In practice, when the user desires to access the gaming system, the following steps are performed:
1. The user installs the appropriate software, on the computer, PDA, or the like, in accordance with the present invention, in order to gain access to the gaming system.
2. An access number, supplied by the gaming system operator, is used to gain access to the gaming system network. This number will be used to supply the corresponding ANI identification of the user's telephone number and DNIS of the originally dialed number.
3. Upon verification of the user's jurisdictional location by the RADIUS server, the user is prompted to insert the gaming card into the card reader. At this point, if ANI is missing from the data string, the call will be rejected. Upon insertion of the Smart Card, a challenge is issued from the RADIUS server to the client.
4. At this stage, the user inputs a personal identification number which is used to create a response to the server's challenge.
5. Upon validation of the challenge, the gaming system allows access to a desired URL through the client browser.

In summary, in an Intranet environment for playing games, the system allows a user to log in and, at the first stage, the system determines the geographic location of the user. Thereafter, the user is authenticated for security purposes, and at that time, the user is able to log in to the particular application they are seeking to address or access. Once access to the particular application is granted, additional security measures, such as PINS or other security techniques may be required in order to complete the log-in process.

The present invention provides improved systems and methods for verifying the geographic location of a user, for enabling the processing of a transaction requiring user location verification, in a secure, effective and efficient manner.

In accordance with the present invention, the improved systems and methods include a system which provides effective and secure authentication of the user location, for enabling requested access to the application server for transaction processing, and for efficient and effective verification of the presence of the user at the location from which the application server access is requested.

Examples of a preferred form of source code for use in carrying out the above described software and firmware steps in conjunction with the hardware as described above, is included in the Provisional Patent Application Appendix attached to this application and incorporated herein.

It will be apparent from the foregoing that, while particular forms of the invention have been illustrated and described, various modifications can be made without departing from the spirit and scope of the invention. Accordingly, it is not intended that the invention be limited, except as by the appended claims.

What is claimed:

1. A jurisdiction verification system, comprising:
an application server;
an authentication server; and
an access server, where the access server is disposed remote to a client device, and wherein the access server is adapted to communicate information between the client device and the authentication server;
the authentication server adapted to issue a challenge based on a request from the client device to access the application server and to receive a response based on the challenge, the response including information provided by a user at the client device, and wherein the information does not include GPS information, so as to determine a geographic location of the client device based on the response.

2. The jurisdiction verification system of claim 1, wherein the application server is adapted to accept the wager-based transactions, and wherein the authentication server is further adapted to authorize communication between the client device and the application server based on the response.

3. The jurisdiction verification system of claim 2, wherein the application server is adapted to accept the wager-based transactions, the response includes a geographic identifier, and the authentication server is further adapted to authorize communication between the client device and the application server if the geographic identifier is indicative of a predetermined geographic location.

4. The jurisdiction verification system of claim 2, wherein the predetermined geographic location is within a jurisdiction that allows wager-based transactions.

5. The jurisdiction verification system of claim 2, wherein the predetermined geographic location is within a jurisdiction that allows remote wager-based transactions.

6. The jurisdiction verification system of claim 2, wherein the predetermined geographic location is within a jurisdiction that allows wager-based transactions from the predetermined geographic location to another geographic location within another jurisdiction.

7. The jurisdiction verification system of claim 6, wherein the geographic identifier includes ANI information.

8. The jurisdiction verification system of claim 6, wherein the geographic identifier includes an IP address.
